(19) United States
(12) Patent Application Publication
(10) Pub. No.: US 2021/0182672 A1
(43) Pub. Date: Jun. 17, 2021

(54) SELF-ORGANIZING MAP LEARNING DEVICE AND METHOD, NON-TRANSITORY COMPUTER READABLE MEDIUM STORING SELF-ORGANIZING MAP LEARNING PROGRAM AND STATE DETERMINATION DEVICE

(71) Applicant: MegaChips Corporation, Osaka (JP)

(72) Inventor: Hiromu HASEGAWA, Osaka (JP)

(73) Assignee: MegaChips Corporation, Osaka (JP)

(21) Appl. No.: 17/105,651

(22) Filed: Nov. 27, 2020

(30) Foreign Application Priority Data
Dec. 12, 2019 (JP) 2019-224869

(51) Int. Cl. G06N 3/08; G06N 3/04

(52) U.S. Cl. CPC G06N 3/08; G06N 3/04

(57) ABSTRACT

A Self-Organizing Map learning device includes a distance calculator that obtains a distance D between an input vector in an observation space and a reference vector of each neuron in a latent space, a smallest value neuron specifier that specifies a smallest value neuron having the smallest distance D, a neuron selector that selects M (M is an integer smaller than L) selection neurons from the L (L is equal to or larger than 2) smallest value neurons in a case where the L smallest value neurons are present, and an updater that updates the reference vector of each neuron in the latent space with the M selection neurons as winner neurons.

### CROSS-REFERENCE TO RELATED APPLICATION

This application is based on and claims the benefit of priority from Japanese Patent Application No. 2019-224869 filed on Dec. 12, 2019, the entire contents of which are incorporated herein by reference.

### BACKGROUND

### Technical Field

The present invention relates to a technique for producing a Self-Organizing Map and a technique for determining a state in an observation space using the produced Self-Organizing Map.

### Description of Related Art

A Self-Organizing Map (SOM) is a neural network that performs unsupervised learning. A SOM has excellent clustering ability to automatically classify input vectors in accordance with degrees of their similarities, With the SOM, it is possible to project a high-dimensional input vector on a low-dimensional map by mapping the input vector in a high-dimensional observation space into a vector in a latent space that is lower dimensional than the observation space. With the SOM, it is possible to perform clustering of the input vector by observing the projected two-dimensional map, for example.

In JP 2017-215798 A, learning is performed with traffic data as an input vector, and a Self-Organizing Map is produced.

### SUMMARY

In JP 2017-215798 A, when the Self-Organizing Map is produced, a process of determining a winner unit and updating a weight vector of the winner unit is executed. Further, in JP 2017-215798 A, a process of updating a weight vector of a neighborhood unit located in the vicinity of the winner unit is executed.

An object of the present invention is to effectively reflect a state represented by an input vector in an observation space on a Self-Organizing Map.

(1) A Self-Organizing Map learning device according to one aspect of the present invention that converts an observation space into a latent space that is lower dimensional than the observation space, includes circuitry configured to obtain a distance D between an input vector in the observation space and a reference vector of each neuron in the latent space, specify a smallest value neuron having the smallest distance D, select M (M is an integer smaller than L and the number of the selection neurons) selection neurons from the L (L is equal to or larger than 2 and the number of the smallest value neurons) smallest value neurons in a case where the L smallest value neurons are present and update the reference vector of each neuron in the latent space with the M selection neurons as winner neurons.

The present invention can improve learning efficiency as compared to a case where a single winner neuron is selected.

(2) The selecting may include selecting the M selection neurons randomly from the L smallest value neurons. Randomness can be provided to a learning process.

(3) The updating may include dividing output of a neighborhood function by M. A learning rate with respect to one input vector is prevented from becoming too large.

(4) The selecting may include setting the number M of neurons to be selected variable with respect to a learning period t of time. Randomness can be provided to the learning process.

(5) The obtaining may include dividing the distance D by an adjustment value A (A is a numerical value larger than 1). A neuron having a distance close to a smallest distance can learn as a winner neuron, and learning efficiency is improved.

(6) The adjustment value A may be expressed by a function f(t) that decreases as the learning period t of time increases. A range of learning can be set wide in an initial stage of learning, and the leaning process can be executed locally as learning proceeds.

(7) A value between f(t)−b and f(t)+Fb may be set randomly with use of an adjustment width b as the adjustment value A with respect to a function f(t) that decreases as a learning period t of time increases. Randomness can be provided to the learning process.

(8) The adjustment width b may be set variable with respect to the learning period t of time. Randomness can be provided to the learning process.

(9) The adjustment value A may follow a normal distribution which takes f(t) as an average value with respect to a function f(t) that decreases as a learning period t of time increases. Randomness can be provided to the learning process.

(10) Variance of the normal distribution may be set variable with respect to the learning period t of time. Randomness can be provided to the learning process.

(11) The distance may include a Euclidean distance.

(12) The distance may include a Hamming distance.

(13) A state determination device according to another aspect of the present invention includes circuitry configured to acquire an input vector from observation data obtained by measurement of an unknown event of an observation space, convert the input vector into data in a latent space with use of a Self-Organizing Map learned by the learning method according to the above-mentioned (1) to (12) and determine a state of the observation space based on SOM output data acquired by the converting.

(14) The present invention is also directed to a failure determination device.

(15) The present invention is also directed to a Self-Organizing Map Learning method and a non-transitory computer readable medium storing a Self-Organizing Map Learning program.

(16) The present invention is also directed to a state determination method and a non-transitory computer readable medium storing a state determination program.

Other features, elements, characteristics, and advantages of the present disclosure will become more apparent from the following description of preferred embodiments of the present disclosure with reference to the attached drawings.

### BRIEF DESCRIPTION OF THE DRAWING

FIG. 1 is a block diagram of the functions of a SOM learning device according to the present embodiment;

FIG. 2 is a conceptual diagram of a SOM learning process;

FIG. 3 is a block diagram of a smallest value neuron acquirer;

FIG. 4 is a block diagram of a neuron selector;

FIG. 5 is a block diagram of an updater;

FIG. 6 is a diagram showing an example of a learning process using the Euclidean distance;

FIG. 7 is a diagram showing an example of a learning process using the Hamming distance;

FIG. 8 is a diagram showing an appliance in which a failure determination device according to the present embodiment is provided;

FIG. 9 is a block diagram of the functions of the failure determination device;

FIG. 10 is a diagram showing a computer that executes the SOM leaning device and the failure determination device by a program;

FIG. 11 is a flowchart showing the SOM learning process; and

FIG. 12 is a flowchart showing a failure determination process.

### DETAILED DESCRIPTION

[1] Learning Process Using SOM

A SOM learning process according to embodiments of the present invention will be described next with reference to the attached drawings.

(1) Configuration of SOM Learning Device

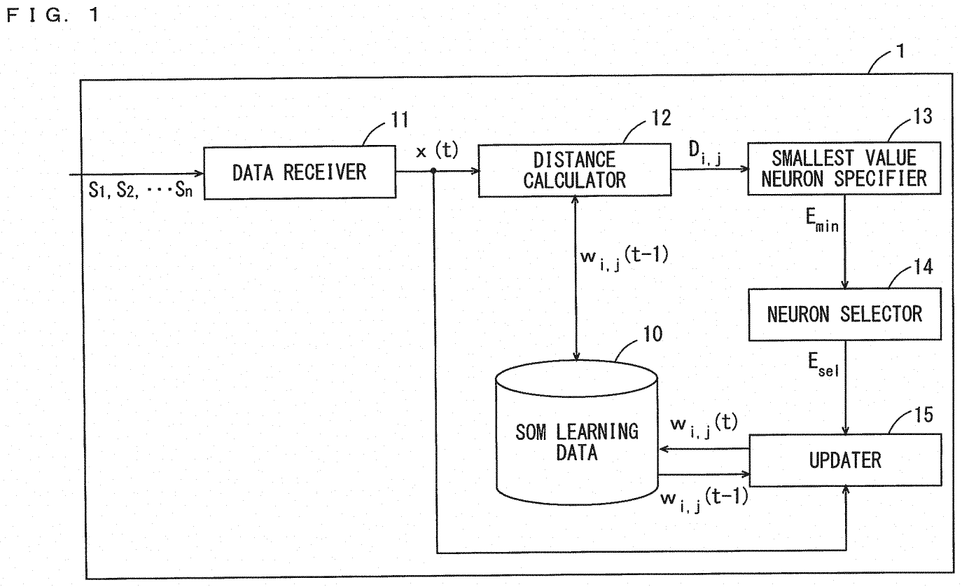

FIG. 1 is a block diagram of the functions of a SOM learning device 1 according to the present embodiment. As shown in FIG. 1, the SOM learning device 1 includes SOM learning data 10, a data receiver 11, a distance calculator 12, a smallest value neuron specifier 13, a neuron selector 14 and an updater 15.

The SOM learning data 10 is stored in a storage device such as a hard disc or a memory. In the present embodiment, the data receiver 11, the distance calculator 12, the smallest value neuron specifier 13, the neuron selector 14 and the updater 15 are constituted by a hardware circuit, by way of example. However, part or all of these functions 11 to 15 may be implemented by a CPU (Central Processing Unit) and a program that runs on the CPU. Embodiments in which these functions 11 to 15 are implemented by the program will be described below.

The data receiver 11 receives an observation data piece S₁, S₂, . . . , Sₙ. The observation data pieces S₁, S₂, . . . , Sₙ are the data pieces on which production of an input vector x(t) is based. While the data receiver 11 receives the n-dimensional observation data pieces S₁, S₂, . . . , Sₙ in the present embodiment, the data that is received by the data receiver 11 is not limited in particular. The data receiver 11 may receive digital signals or analogue signals in a chronological order.

The data receiver 11 produces an input vector x(t) based on the observation data pieces S₁, S₂, . . . , Sₙ. The data receiver 11 outputs the input vector x(t) to the distance calculator 12. Further, the data receiver 11 outputs the input vector x(t) to the updater 15.

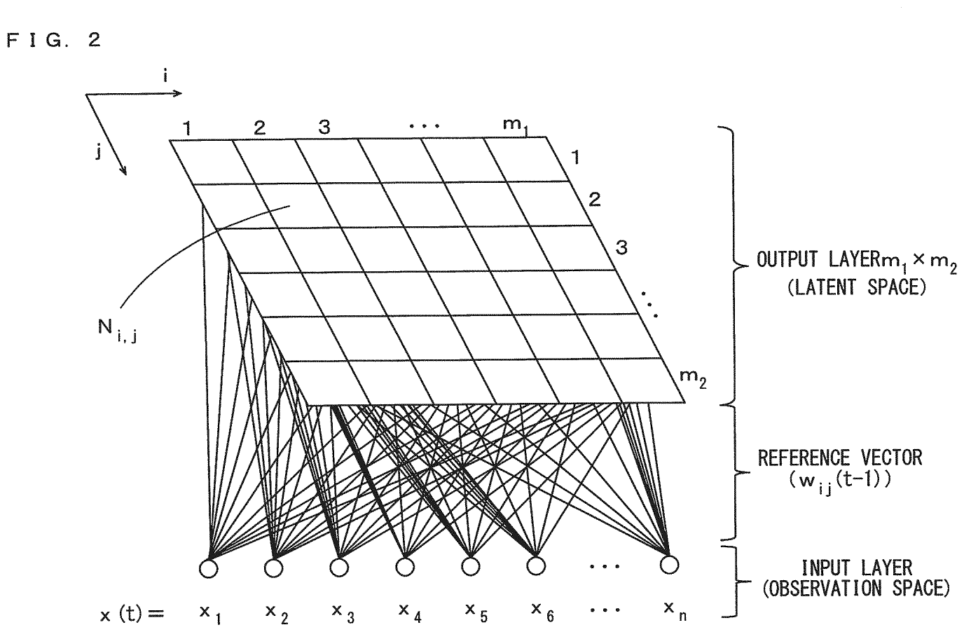

FIG. 2 is a conceptual diagram of the SOM learning process. In FIG. 2, an input layer is a layer in which an input vector x(t) of an observation space is input. In FIG. 2, an output layer is a layer in which neurons (nodes) of a latent space are arranged. In this example, the output layer has an oblong region of m₁×m₂, and m₁×m₂ neurons are arranged. A neuron N_{i, j} (i=1, 2, . . . , m₁, j=1, 2, . . . , m₂) of the output layer holds a reference vector w_{i, j} (t−1) representing one point in the input layer.

The distance calculator 12 calculates the distance D_{i, j} between an input vector x(t) and a reference vector w_{i, j} (t−1). The distance calculator 12 calculates the distance D_{i, j} between an input vector x(t) and a reference vector w_{i, j} (t−1) in regard to all of the neurons in the latent space. The distance calculator 12 calculates the Euclidean distance between an input vector x(t) and a reference vector w_{i, j} (t−1), for example, as the distance D_{i, j}. Alternatively, the distance calculator 12 calculates the Hamming distance between an input vector x(t) and a reference vector w_{i, j} (t−1) as the distance D_{i, j}.

The smallest value neuron specifier 13 receives the distance D_{i, j} from the distance calculator 12. The smallest value neuron specifier 13 receives the distances D_{i, j} calculated by the distance calculator 12 in regard to all of N_{i, j}. That is, the smallest value neuron specifier 13 receives m₁×m₂ distances D_{i, j}. The smallest value neuron specifier 13 specifies the distance D_{i, j} that is the smallest value among the received m₁×m₂ distances D_{i, j}. That is, the smallest value neuron specifier 13 specifies the neuron N_{i, j} that has the smallest distance from the input vector x(t). The smallest value neuron specifier 13 outputs smallest value neuron designating information Eₘᵢₙ representing the specified smallest value neuron N_{p, q} to the neuron selector 14.

The smallest value neuron designating information Eₘᵢₙ is represented by the following formula.

Eₘᵢₙ={(p, q)|D_{p, q}≤D_{i, j}} (0≤i≤m₁, 0≤j≤m₂)

In a case where a plurality of smallest value neurons N_{p, q} have the smallest distance from the input vector x(t), the smallest value neuron specifier 13 includes the information designating the plurality of smallest value neurons N_{p, q} in the smallest value neuron designating information Eₘᵢₙ. The configuration of the smallest value neuron specifier 13 will be described below in detail.

The neuron selector 14 receives the smallest value neuron designating information Eₘᵢₙ from the smallest value neuron specifier 13. The neuron selector 14 selects part of the neurons as selection neurons N_{P, Q} from among the plurality of smallest value neurons N_{p, q} specified by the smallest value neuron designating information Emir. In the present embodiment, from among the L (L is an integer and the number of the smallest value neurons) smallest value neurons N_{p, q} specified by the smallest value neuron designating information Eₘᵢₙ, the neuron selector 14 selects M (M is an integer smaller than L and the number of the selection neurons) neurons as the selection neurons N_{P, Q}. However, in a case where the number of the smallest value neuron N_{p, q} is 1 (L=1), the smallest value neuron N_{p, q} is selected as the selection neuron N_{P, Q} without selection. Selection neuron designating information Eₛₑₗ is represented by the following formula.

$${E}_{\text{?} \text{?} \text{?}} = [ ( P , Q ) \vert {E}_{\text{?} \text{?}} ⋐ {E}_{\text{?} \text{?}} , \cdot {E}_{\text{?} \text{?}} \text{?} \\ \text{?} \text{indicates text missing or illegible when filed}$$

is.a.set.obtained.by.selecting.M.elements.from.Eₘᵢₙ}

Further, a selection neuron N_{P, Q} is represented by the following formula.

N_{P, Q}=N_{i, j} ((i, j)⊂Eₛₑₗ)

The neuron selector 14 outputs the selection neuron designating information Eₛₑₗ representing a selected selection neuron N_{P, Q} to the updater 15. The configuration of the neuron selector 14 will be described below in detail.

The updater 15 receives the selection neuron designating information Eₛₑₗ from the neuron selector 14. Further, the updater 15 receives an input vector x(t) from the data receiver 11. The updater 15 executes an update process of a reference vector in regard to all of the selection neurons N_{P, Q} designated by the selection neuron designating information Eₛₑₗ.

The update process to be executed by the updater 15 is specifically described below. With reference to the SOM learning data 10, the updater 15 acquires a reference vector w_{P, Q} (t−1) in regard to each selection neuron N_{P, Q}. Next, the updater 15 updates the reference vector w_{P, Q} (t−1) based on the distance between an input vector x(t) and the reference vector w_{P, Q} (t−1). When the reference vector w_{P, Q}(t−1) is updated, a learning rate is determined by a neighborhood function h.

Further, the updater 15 determines neighborhood neurons Nₙₑₐᵣ that learn together with a selection neuron N_{P, Q} using the neighborhood function h. The updater 15 determines neighborhood neurons Nₙₑₐᵣ for each selection neuron N_{P, Q}. Then, the updater 15 also updates a reference vector wₙₑₐᵣ (t−1) based on the distance between an input vector x(t) and a reference vector wₙₑₐᵣ (t−1) in regard to a neighborhood neuron Nₙₑₐᵣ. In regard to all of the M selection neurons N_{P, Q}, the updater 15 executes the update process of a reference vector w_{i, j} (t−1) with respect to a selection neuron N_{P, Q} and a neighborhood neuron Nₙₑₐᵣ.

The neighborhood function h determines an amount of distribution of the learning rate based on the position information of a neuron N_{i, j} and the position information of a winner neuron. With the neighborhood function h, the closer a neuron is to a winner neuron, the larger the amount of distribution of the learning rate is. In the present embodiment, the M selection neurons N_{P, Q} are used as winner neurons. Further, with the neighborhood function h, the larger a period t of time is, the smaller the amount of distribution of the learning rate is.

The SOM learning device 1 receives a plurality of input vectors x(t) and executes the update process of each reference vector W_{i, j} (t−1). Further, the SOM learning device 1 executes the update process of a reference vector w_{i, j}(t−1) multiple times in regard to one input vector x(t). Thus, a reference vector w_{i, j} stored in the SOM learning data 10 is updated, and the learning process of the SOM learning device 1 is executed.

(2) Configuration of Smallest Value Neuron Specifier

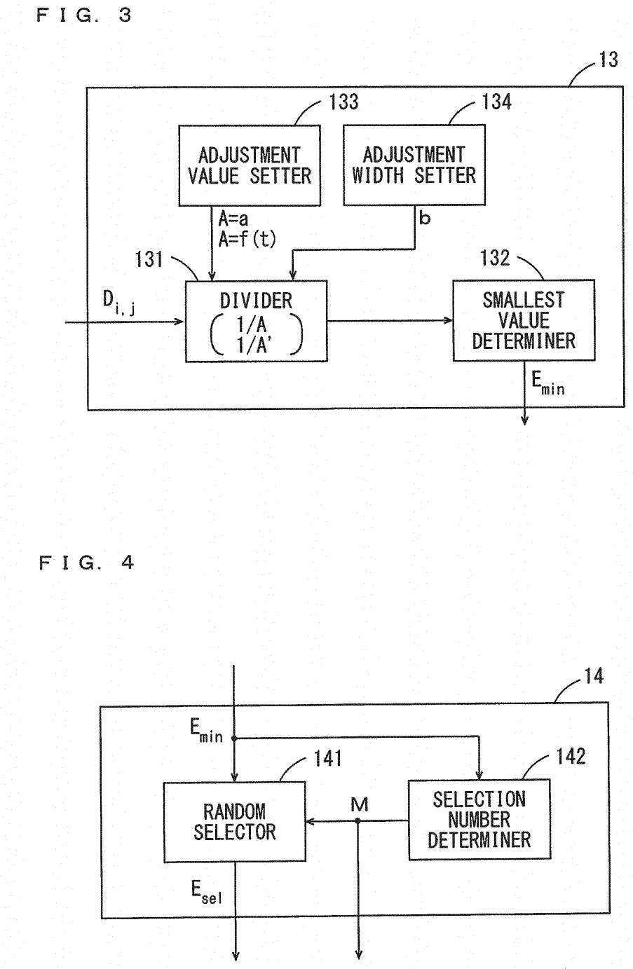

Next, the configuration of the smallest value neuron specifier 13 will be described. FIG. 3 is a block diagram of the functions of the smallest value neuron specifier 13. The smallest value neuron specifier 13 includes a divider 131, a smallest value determiner 132, an adjustment value setter 133 and an adjustment width setter 134.

(2-1) Division by Adjustment Value A

The adjustment value setter 133 produces an adjustment value A. The adjustment value setter 133 outputs the adjustment value A to the divider 131. The divider 131 receives the adjustment value A that is output by the adjustment value setter 133. Further, the divider 131 receives a distance D_{i, j} that is output by the distance calculator 12. The divider 131 divides the distance by the adjustment value A (A=a) (‘a’ is a real number). The smallest value determiner 132 receives m₁×m₂ distances D_{i, j} that are divided by the adjustment value A and determines the smallest distance D_{i, j}. The smallest value determiner 132 specifies a smallest value neuron N_{p, q} based on the determined smallest distance D_{i, j} and produces smallest value neuron designating information Eₘᵢₙ. The smallest value determiner 132 outputs the smallest value neuron designating information Eₘᵢₙ to the neuron selector 14.

In a case where “1” is set as the adjustment value A, the smallest value determiner 132 evaluates the distance D_{i,j} that is received from the distance calculator 12 without adjustment and specifies a smallest value neuron N_{p,q}. In a case where a real number that is larger than 1 is set as the adjustment value A, the smallest value determiner 132 divides the distance D_{i, j} that is received from the distance calculator 12 by the adjustment value A and then specifies a smallest value neuron N_{p, q}. That is, the distance D_{i, j} is divided by the adjustment value A in the divider 131, so that the resolution of the distance D_{i, j} is degraded. For example, in a case where the two distances D_{i, j} are “100” and “101,” when the distances D_{i, j} are evaluated without adjustment by setting the adjustment value A as “1,” “100” is smaller between the distances D_{i, j}. However, in a case where the distance D_{i, j} is divided by the adjustment value A (A=“10”) that is larger than 1, and the distances D_{i, j} are taken as integer values, both of the distances are “10,” In this manner, the resolution of the distance D_{i, j} is degraded, so that a neuron having a value close to the smallest value is also adjusted so as to be selected as a smallest value neuron N_{p, q}.

(2-2) Production of Adjustment Value A by Function f(t)

In the above-mentioned (2-1), a constant ‘a’ such as an integer or a real number is used as the adjustment value A. The smallest value neuron specifier 13 of the present embodiment can use a function f(t) that is a function of the time t as the adjustment value A. The adjustment value A is represented as follows by the function f(t).

A=f(t)

The function f(t) is a monotonically decreasing function of narrow and broad definitions. That is, the larger the learning period t of time is, the smaller the function f(t) is. Thus, in an initial stage of the learning process, the degree of reduction in resolution of a distance D_{i, j} is increased, and the range of neurons that learn as smallest value neurons N_{p, q} is widened. On the other hand, as the learning process proceeds, the degree of reduction in resolution of the distance D_{i, j} can be reduced, and the range of neurons that learn as smallest value neurons N_{p, q} can be narrowed. In this manner, learning can be performed broadly in the initial stage of learning, and the learning process can be performed locally as the learning process proceeds.

Further, the adjustment value setter 133 may set the adjustment value A to a value that follows the normal distribution that takes f(t) as an average value with respect to the function f(t). As described above, the function f(t) is a monotonically decreasing function of narrow and broad definitions. Thus, it is possible to provide randomness to the learning process by providing variations to the adjustment value A while causing the learning process to be performed locally as the learning period t of time increases. Further, in the normal distribution that takes f(t) as an average value, its variance may be set variable with respect to the learning period t of time. This can further provide randomness to the learning process.

### (2-3) Addition of Adjustment Width b to Adjustment Value A

In the above-mentioned (2-1) and (2-2), the divider 131 divides a distance D_{i, j} by the adjustment value A. The smallest value neuron specifier 13 of the present embodiment can add an adjustment width b to the adjustment value A. As shown in FIG. 3, the smallest value neuron specifier 13 includes an adjustment width setter 134, The adjustment width setter 134 outputs the adjustment width b. The adjustment width b is a constant such as an integer or a real number.

The divider 131 receives the adjustment value A that is output by the adjustment value setter 133. Further, the divider 131 receives the adjustment width b that is output by the adjustment width setter 134. The divider 131 divides a distance D_{i, j} by a correction adjustment value A′. The correction adjustment value A′ is a value between A−b and A+b and is randomly selected. In a case where the adjustment value A is a constant ‘a,’ a value between a−b and a+b is randomly selected as the correction adjustment value A′. In a case where the adjustment value A is a function f(t), a value between f(t)−b and f(t)+b is randomly selected as the correction adjustment value A′. In this manner, a value between A−b and A+b is randomly selected as the correction adjustment value A′, randomness can be provided to the correction adjustment value A′.

This can provide randomness to the determination process of a smallest value neuron N_{p, q} in the smallest value determiner 132 and can improve the learning effects.

Further, the adjustment width setter 134 of the present embodiment can set the adjustment value b variable with respect to the learning period t of time. That is, the adjustment width setter 134 can set a value that changes with respect to the period t of time as the adjustment width b. For example, the adjustment width setter 134 includes a random number generator and can randomly set the adjustment width b. At this time, the adjustment width setter 134 can set the adjustment width b in a predetermined value range.

(3) Configuration of Neuron Selector

Next, the configuration of the neuron selector 14 will be described. FIG. 4 is a block diagram of the functions of the neuron selector 14. The neuron selector 14 includes a random selector 141 and a selection number determiner 142.

The selection number determiner 142 receives smallest value neuron designating information Eₘᵢₙ that is output by the smallest value neuron specifier 13. The selection number determiner 142 outputs a selection number M based on the smallest value neuron designating information Eₘᵢₙ. Specifically, the selection number determiner 142 acquires the number L of smallest value neurons N_{p, q} with reference to the smallest value neuron designating information Eₘᵢₙ. The selection number determiner 142 has a random number generator and randomly determines a selection number M that is smaller than the number L of the smallest value neurons N_{p, q}. In this manner, the selection number M is set variable with respect to the learning period t of time, so that randomness can be provided to the learning process.

The random selector 141 receives the smallest value neuron designating information Eₘᵢₙ that is output by the smallest value neuron specifier 13. Further, the random selector 141 receives the selection number M from the selection number determiner 142. The random selector 141 has a random number generator and randomly selects M selection neurons N_{P, Q} a from among the L smallest value neurons N_{p, q}. The random selector 141 outputs selection neuron designating information Eₛₑₗ representing a randomly selected selection neuron N_{P, Q} to the updater 15. This enables random selection of the M selection neurons N_{P, Q} from among the L smallest value neurons N_{p, q} in the neuron selector 14 and improvement of the learning effects. Further, because the selection number M of selection neurons is randomly set, the learning effects can further be improved.

(4) Configuration of Updater

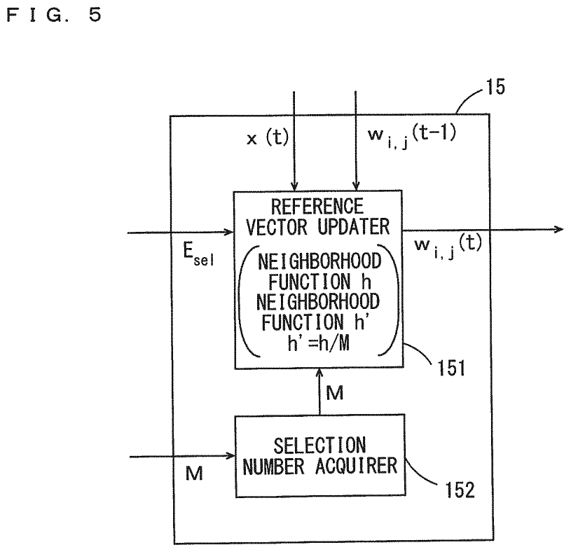

Next, the configuration of the updater 15 will be described. FIG. 5 is a block diagram of the functions of the updater 15. The updater 15 includes a reference vector updater 151 and a selection number acquirer 152.

The reference vector updater 151 acquires a reference vector w_{i, j} (t−1) with reference to the SOM learning data 10. Further, the reference vector updater 151 acquires an input vector x(t) that is output by the data receiver 11. Further, the reference vector updater 151 receives selection neuron designating information Eₛₑₗ that is output by the neuron selector 14. The reference vector updater 151 updates a reference vector w_{i, j} (t−1) with M selection neurons NP, Q as winner neurons. As described above, in regard to all of the M selection neurons N_{P, Q}, the updater 15 executes an update process of a reference vector w_{i, j} (t−1) with respect to a selection neuron N_{P, Q} and the neighborhood neurons Nₙₑₐᵣ.

Here, the reference vector updater 151 determines a learning rate of the reference vector w_{i, j} (t−1) using a neighborhood function h. Further, the reference vector updater 151 determines neighborhood neurons Nₙₑₐᵣ to be updated as well as a winner neuron using the neighborhood function h. The neighborhood function h is a monotonically decreasing function in regard to t and converges to 0 when t becomes infinite. Further, the neighborhood function h monotonically decreases with respect to the distance between each neuron N_{i, j} and a selection neuron N_{P, Q} in the output layer (latent space). Further, the larder t is, the larger the degree of monotonical decrease is.

The reference vector updater 151 of the present embodiment can use a neighborhood function h′ instead of a normal neighborhood function h. The neighborhood function h′ is represented by the following formula,

h′=h/M

That is, the neighborhood function h′ is a function obtained by division of the normal neighborhood function h by the selection number M. The selection number acquirer 152 acquires the selection number M from the selection number determiner 142 of the neuron selector 14. The reference vector updater 151 acquires the selection number M from the selection number acquirer 152, divides the neighborhood function h by M and obtains the neighborhood function h′. The reference vector updater 151 can reduce an amount of distribution of learning by using the neighborhood function h′ instead of the normal neighborhood function h. As described above, in the present embodiment, the update process is executed with the M selection neurons N_{P, Q} selected by the neuron selector 14 as winner neurons. As such, it is possible to prevent an amount of distribution of learning with respect to one input vector x(t) from becoming too large by using the neighborhood function h′.

(5) Specific Examples of SOM Learning Process

Next, specific examples of the SOM learning process executed by the SOM learning device 1 which is configured as described above will be described. In the following description, a specific example for use of the Euclidean distance and a specific example for use of the Hamming distance in the SOM learning process will be described,

(5-1) Example of Learning Process Using Euclidean Distance

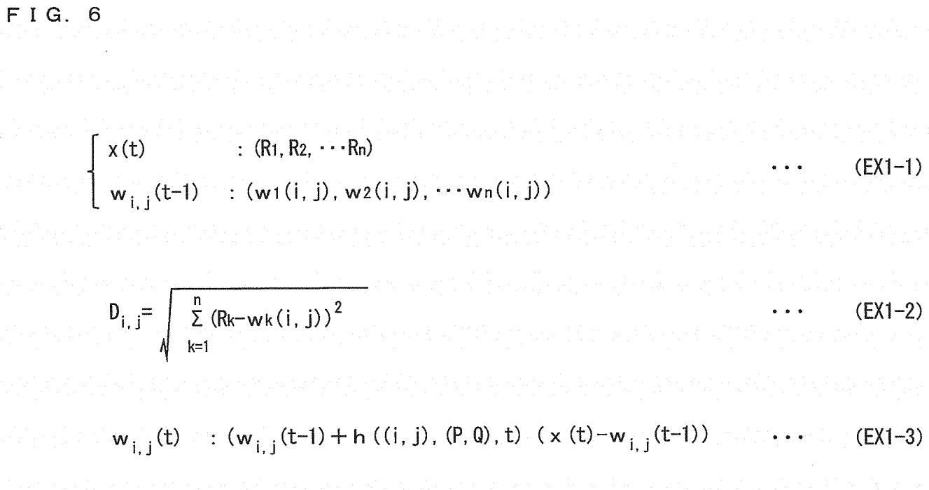

First, a specific example for use of the Euclidean distance in the SOM learning process will be described. FIG. 6 is a diagram showing a vector and calculation methods used in the SOM learning process using the Euclidean distance.

The data receiver 11 (see FIG. 1) receives observation data pieces S₁, S₂, . . . , Sₙ and outputs an input vector x(t) (x(t)=(R₁, R₂, . . . , Rₙ)) (EX1-1 of FIG. 6). R₁, R₂, . . . , Rₙ are real numbers. For example, in regard to the observation data pieces S₁, S₂, . . . , Sₙ, it may be that S₁=R₁, S₂=R₂, . . . , Sₙ=Rₙ, and the input vector x(t) may be acquired by vectorization of the observation data pieces S₁, S₂, . . . , Sₙ. Alternatively, the input vector x(t) (x(t)=(R₁, R₂, . . . , Rₙ)) may be a feature vector obtained by extraction of feature data from the observation data pieces S₁, S₂, . . . , Sₙ.

Next, the distance calculator 12 (see FIG. 1) calculates a distance D_{i, j} between the input vector x(t) (x(t)=(R₁, R₂, . . . , Rₙ)) and a reference vector w_{i, j} (t−1) ((w_{i, j} (t−1)=(w₁(i, j), w₂(i, j), . . . , wₙ(i, j))). As shown in (EX1-2) of FIG. 6, the distance calculator 12 calculates the distance D_{i, j} using the Euclidean distance.

Next, a smallest value neuron N_{p, q} is specified by the smallest value neuron specifier 13, and a selection neuron N_{P, Q} is further selected by the neuron selector 14. The contents of processes executed by the smallest value neuron specifier 13 and the neuron selector 14 are similar to those described with reference to FIGS. 3 and 4. That is, the smallest value neuron specifier 13 specifies the smallest value neuron N_{p, q} by using a real number ‘a’ or a function f(t) as an adjustment value A and dividing the distance by the adjustment value A. Alternatively, the smallest value neuron specifier 13 specifies the smallest value neuron N_{p, q} by calculating a correction adjustment value A′ using an adjustment width b and dividing the distance D_{i, j} by a correction adjustment value A′. Further, the neuron selector 14 selects M selection neurons N_{P, Q} from among L smallest value neurons N_{p, q} using a selection number M.

Subsequently, the updater 15 executes an update process of a reference vector w_{i, j} (t−1). As shown in (EX 1-3) of FIG. 6, the updater 15 executes the update process of the reference vector w_{i, j} (t−1) with a neighborhood function h((i, j), (P, Q), t) as a coefficient. As described above, (P, Q) is the information that designates a selection neuron N_{P, Q}, and N_{P, Q}=N_{i, j} ((i, j)⊂Eₛₑₗ). With the neighborhood function h, the closer a neuron N_{i, j} is to a selection neuron N_{P, Q} that is a winner neuron, the larger an amount of distribution of the learning rate is. Further, with the neighborhood function h, the larger a period t of time is, the smaller an amount of distribution of the learning rate is. With the above-mentioned learning process, the SOM learning device 1 executes the update process of a reference vector w_{i, j} (t−1) using the Euclidean distance. Further, as described with reference to FIG. 5, the updater 15 can use a neighborhood function h′ obtained by division of a neighborhood function h by a selection number M. This can suppress an increase in impact one input vector x(t) has on learning,

(5-2) Example of Learning Process Using Hamming Distance

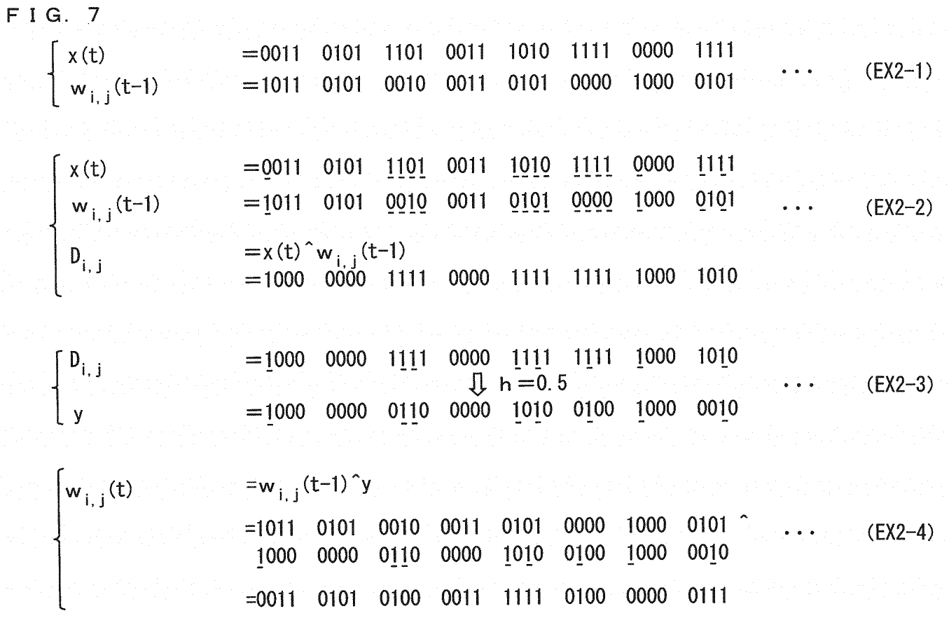

Next, a specific example for use of the Hamming distance in the SOM learning process will be described. FIG. 7 is a diagram showing vectors and calculation methods used in the SOM learning process using the Hamming distance,

The data receiver 11 (see FIG. 1) receives observation data pieces S₁, S₂, . . . , Sₙ. S₁, S₂, . . . , Sₙ are bit strings of p bit. An input vector x(t) is a vector in which observation data pieces S₁, S₂, . . . , Sₙ are bonded in the order of S₁, S₂, . . . , Sₙ and is a bit string of p×n bit. Alternatively, the input vector x(t) is a feature vector (bit string) obtained by extraction of feature data from observation data pieces S₁, S₂, . . . , Sₙ. In FIG. 7, the input vector x(t) is represented by a bit string of 32 bit. Further, as shown in (EX2-1) of FIG. 7, in a case where a bit string of 32 bit is used as the input vector x(t), the reference vector w_{i, j} (t−1) is represented by a bit string of 32 bit. In FIG. 7, a specific example of a bit string of 32 bit is shown as x(t) and a reference vector w_{i, j} (t−1).

Next, the distance calculator 12 (see FIG. 1) calculates a distance D_{i, j} between the input vector x(t) and the reference vector w_{i, j} (t−1). As shown in (EX2-2) of FIG. 7, the distance calculator 12 calculates the distance D_{i, j} (Hamming distance) by calculating an exclusive logical sum (XOR:exclusive OR) of the input vector x(t) and the reference vector w_{i, j} (t−1). The distance between the input vector x(t) and the reference vector w_{i, j} (t−1) is evaluated based on the number of “1” included in the bit string in the distance D_{i, j}. The smaller the number of “1” included in the bit string is, the smaller the distance D_{i, j} is evaluated to be.

Next, a smallest value neuron N_{p, q} is specified by the smallest value neuron specifier 13, and a selection neuron N_{P, Q} is further selected by the neuron selector 14. The contents of processes executed by the smallest value neuron specifier 13 and the neuron selector 14 are similar to those described with reference to FIGS. 3 and 4. However, the smallest value neuron specifier 13 specifies a neuron having the smallest number of “1” in the distance D_{i, j} calculated with use of the Hamming distance as a smallest value neuron N_{P, Q}.

Subsequently, the updater 15 executes an update process of a reference vector w_{i, j} (t−1). As shown in (EX2-3) of FIG. 7, the updater 15 determines the number of bits for learning based on a neighborhood function h ((i, j), (P, Q), t). Here, a neighborhood function h is calculated to be 0.5 (the neighborhood function h=0.5), by way of example, As shown in the specific example of (EX2-2), bits “1” are included in 16 points in the distance D_{i, j} calculated by the Hamming distance. Further, because the neighborhood function h=0.5, 16×0.5=8, and 8 bits “1” are randomly selected from among 16 bits “1.” In (EX2-3), the example of bits where 8 bits “1” are randomly selected is indicated by a learning selection vector y. That is, while the neighborhood function h is used as a multiplication coefficient in the calculation of learning rate in the learning process using the Euclidean distance, the neighborhood function h is used to determine the number of bits for learning in the learning process using the Hamming distance.

Next, the updater 15 calculates an exclusive logical sum of the reference vector w_{i, j} (t−1) and the learning selection vector y and executes the learning process of the reference vector w_{i, j} (t−1). The updated reference vector w_{i, j} (t) is shown in (EX2-4) of FIG. 7.

As described above, in a case where L (L is equal to or larger than 2) smallest value neurons N_{P, Q} are present, the SOM learning device 1 of the present embodiment selects M (M is an integer smaller than L) selection neurons N_{P, Q} from among L smallest value neurons N_{p, q}. Then, the SOM learning device 1 updates a reference vector w_{i, j} (t−1) of each neuron in a latent space with the M selection neurons N_{P, Q} as winner neurons. Thus, learning efficiency can be improved as compared to a case where a single winner neuron is selected.

[2] Failure Determination Process by SOM

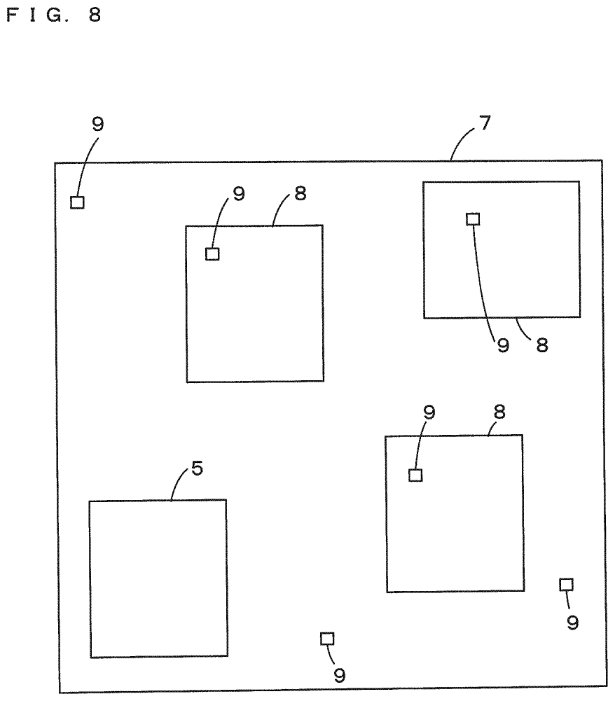

Next, the failure determination process utilizing the above-mentioned SOM learning data 10 will be described. FIG. 8 is a diagram showing an appliance 7 in which a failure determination device 5 is provided. A plurality of devices 8 are arranged in the appliance 7. A plurality of sensors 9 are provided on a board or in a device 8 in the appliance 7. The sensor 9 is a sensor for measuring a voltage flowing on a board of the appliance 7 or in the device 8. The sensor 9 outputs a voltage measurement value as an observation data piece S₁, S₂, . . . , Sₙ.

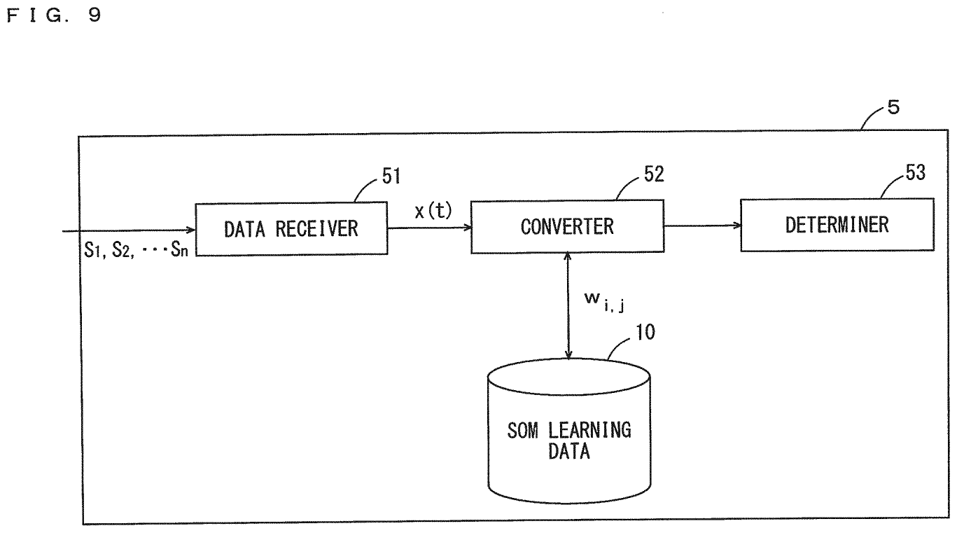

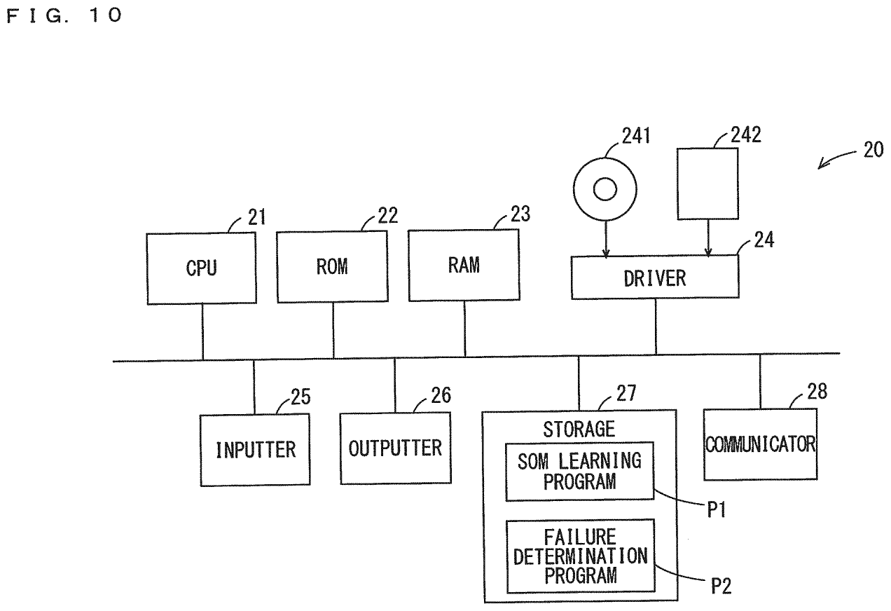

FIG. 9 is a block diagram of the failure determination device 5. The failure determination device 5 includes a data receiver 51, a converter 52, a determiner 53 and

SOM learning data 10. The data receiver 51 receives a voltage measurement value as observation data pieces S₁, S₂, . . . , Sₙ. The data receiver 51 produces an input vector x based on the observation data pieces S₁, S₂, . . . , Sₙ.

The converter 52 receives the input vector x that is output by the data receiver 51. The converter 52 acquires a reference vector W_{i, j} with reference to the SOM learning data 10. The SOM learning data 10 is the data learned by the above-mentioned SOM learning device 1 shown in FIG. 1. As a pre-stage for an operation of the failure determination device 5, the SOM learning device 1 receives a plurality of observation data pieces S₁, S₂, . . . , Sₙ that are output by the sensor 9 of the appliance 7 and updates a reference vector w_{i, j} by a learning process, The SOM learning data 10 included in the failure determination device 5 holds the learned reference vector w_{i,j} .

The converter 52 calculates the distance between the input vector x and the reference vector w_{i, j} and determines a neuron having the smallest distance D_{i, j} as a winner neuron. The converter 52 outputs the position information of the winner neuron in a latent space (output layer) to the determiner 53. The determiner 53 determines a failure type of the input vector x based on the position information of the winner neuron.

The determiner 53 has map information of failure types in advance. That is, the determiner 53 has the map information that associates the position information of a neuron in the latent space of the learned SOM learning data 10 with a failure type. In the failure determination device 5, in a case where any neuron in the latent space fires as a winner neuron, the failure type of the appliance 7 can be determined based on the position information of the firing winner neuron.

[3] Program

In the above-mentioned embodiment, the data receiver 11, the distance calculator 12, the smallest value neuron specifier 13, the neuron selector 14 and the updater 15 included in the SOM learning device 1 are constituted by a hardware circuit, by way of example. Further, the data receiver 51, the converter 52 and the determiner 53 included in the failure determination device 5 are constituted by a hardware circuit, by way of example. Next, the embodiment in which each function 11 to 15, 51 to 53 is implemented by a program that runs on a CPU will be described.

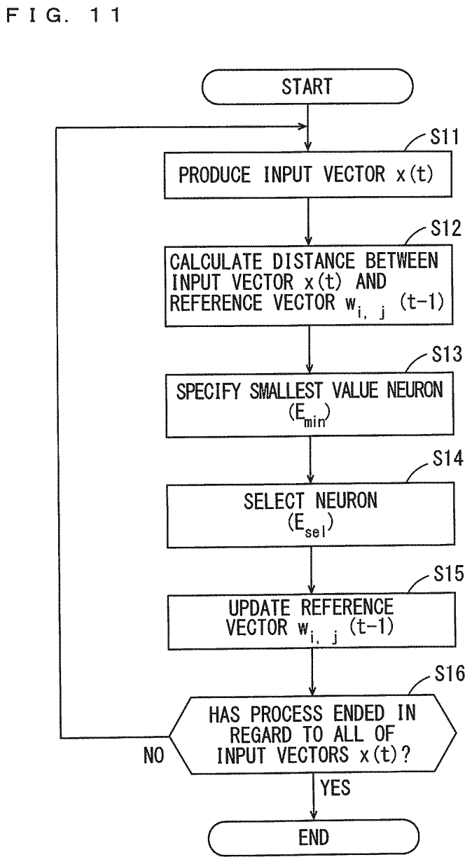

As shown in FIG. 10, a computer 20 includes a CPU 21, a ROM 22, a RAM 23, a driver 24, an inputter 25, an outputter 26, a storage 27 and a communicator 28. These devices are connected via a bus, The storage 27 is a hard disc, for example, and stores a SOM learning program P1 and a failure determination program P2. The ROM 22 is a non-volatile memory, for example. The ROM 22 may store the SCM learning program P1 and the failure determination program P2, The CPU 21 executes the SCM learning program P1 and the failure determination program P2 stored in the storage 27 or the ROM 22 while using the RAM 23 as a work area, thereby performing a SOM learning method and a failure determination method that are described next.

(1) SOM Learning Method

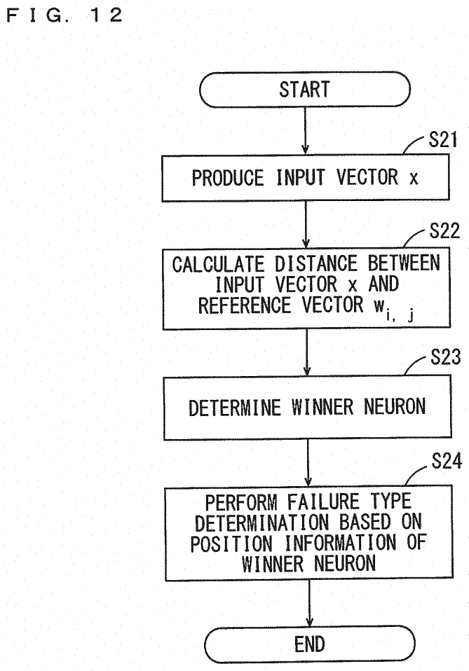

FIG. 11 is a flowchart showing the SOM learning method. First, in the step S11, the computer 20 produces an input vector x(t). Next, in the step S12, the computer 20 calculates a distance D_{i, j} between the input vector x(t) and a reference vector w_{i, j} (t−1). Next, in the step S13, the computer 20 specifies a smallest value neuron N_{p, q} having a smallest distance D_{i, j} and outputs smallest value neuron designating information Eₘᵢₙ. The information designating L smallest value neurons N_{p, q} is included in the smallest value neuron designating information Eₘᵢₙ. Next, in the step S14, the computer 20 randomly selects M selection neurons N_{P, Q} from among the L smallest value neurons N_{p, q} and outputs selection neuron designating information Eₛₑₗ.

Then, in the step S15, the computer 20 executes an update process of the reference vector w_{i, j} (t−1) with one neuron out of the M selection neurons N_{P, Q} designated by the selection neuron designating information Eₛₑₗ as a winner neuron. Subsequently, the computer 20 executes an update process of the reference vector w_{i, j} (t−1) also with the rest of the neurons included in the M selection neurons N_{P, Q} as winner neurons. Next, in the step S16, the computer 20 determines whether the update process of the reference vector w_{i, j} (t−1) has been executed in regard to all of the input vectors x(t). In a case where the update process of the reference vector w_{i, j} (t−1) is not executed in regard to all of the input vectors x(t), the process returns to the step S11, and the update processing of the reference vector W_{i, j} (t−1) is executed in regard to a next input vector x(t). When the update process of the reference vector w_{i, j} (t−1) ends in regard to all of the input vectors x(t), the process of FIG. 11 ends. The computer 20 may further executes the process shown in FIG. 11 multiple times in regard to the same input vector x(t).

(2) Failure Determination Method

FIG. 12 is a flowchart showing the failure determination method. First, in the step S21, the computer 20 produces an input vector x. Then, in the step S22, the computer 20 calculates a distance D_{i, j} between the input vector x and a reference vector w_{i, j}. Next, in the step S23, the computer 20 specifies a neuron N_{i, j} having a smallest distance D_{i, j} and determines the neuron N_{i, j} as a winner neuron.

Next, the computer 20 determines the failure type based on the position information of the winner neuron. For example, the failure type is displayed in an output unit of the computer 20. Alternatively, the map in a latent space and the position of the winner neuron may be displayed in the output unit of the computer 20. The computer ends the failure determination process in regard to the input vector x.

As shown in FIG. 10, the SOM learning program P1 or the failure determination program P2 may be provided while being stored in a non-transitory recording medium (a CD-ROM 241 or a memory card 242, for example) that is readable by the computer 20 via the driver 24, and may be installed in the storage 27 or the ROM 22. Further, in a case where the communicator 28 is connected to a communication network, the SOM learning program P1 or the failure determination program P2 distributed from a server connected to the communication network may be installed in the storage 27 or the ROM

[4] Other Embodiments

In the above-mentioned embodiment, failure determination is performed using the SOM learning data 10, by way of example. For example, the failure determination device 5 can determine an abnormal state of the appliance 7 by using a voltage of the appliance 7 as observation data. Alternatively, also in a case where some sort of an unauthorized operation is performed on the appliance 7, the failure determination device 5 can determine an unauthorized operation performed on the appliance 7.

The failure determination device 5 can detect an abnormal phenomenon that shows an abnormal state of an object to be observed by observing the output of a sensor and a camera, a state of network or the like. As a failure determination subject, a plant such as a power plant or a factory, a mechanical device such as an industrial robot, a vehicle such as a train, an automobile or a motorcycle and an infrastructure facility such as an electric power facility for a building or an air conditioning unit are supposedly included.

While the failure determination device 5 receives a voltage value that is measured by the sensor 9 as observation data in the above-mentioned embodiment, the observation data is not limited to this. For example, the input from a sensor that measures an electric current value, a temperature or a pressure, for example, may be used as observation data.

While the failure determination is performed using the SOM learning data 10 as way of example in the above-mentioned embodiment, the method of using the SOM learning data 10 is not limited to this. For example, a state determination device can be configured to not only determine a failure but also determine a state of the appliance 7 with use of the SOM learning data 10. For example, the state determination device can also be configured as a device that determines an operating state, stability and the like of the appliance 7.

The functionality of the elements disclosed herein may be implemented using circuitry or processing circuitry which includes general purpose processors, special purpose processors, integrated circuits, ASICs (“Application Specific Integrated Circuits”), conventional circuitry and/or combinations thereof which are configured or programmed to perform the disclosed functionality. Processors are considered processing circuitry or circuitry as they include transistors and other circuitry therein. In the disclosure, the circuitry, units, or means are hardware that carry out or are programmed to perform the recited functionality. The hardware may be any hardware disclosed herein or otherwise known which is programmed or configured to carry out the recited functionality. When the hardware is a processor which may be considered a type of circuitry, the circuitry, means, or units are a combination of hardware and software, the software being used to configure the hardware and/or processor.

While preferred embodiments of the present disclosure have been described above, it is to be understood that variations and modifications will be apparent to those skilled in the art without departing the scope and spirit of the present disclosure. The scope of the present disclosure, therefore, is to be determined solely by the following claims.

I/we claim:

1. A Self-Organizing Map learning device that converts an observation space into a latent space that is lower dimensional than the observation space, comprising:
circuitry configured to:
obtain a distance D between an input vector in the observation space and a reference vector of each neuron in the latent space;
specify a smallest value neuron having the smallest distance D;
select M (M is an integer smaller than L) selection neurons from the L (L is equal to or larger than 2) smallest value neurons in a case where the L smallest value neurons are present; and
update the reference vector of each neuron in the latent space with the M selection neurons as winner neurons.

2. The Self-Organizing Map learning device according to claim 1, wherein
the selecting includes selecting the M selection neurons randomly from the L smallest value neurons.

3. The Self-Organizing Map learning device according to claim 2, wherein
the updating includes dividing output of a neighborhood function by M.

4. The Self-Organizing Map learning device according to claim 1, wherein
the selecting includes setting the number M of neurons to be selected variable with respect to a learning period t of time.

5. The Self-Organizing Map learning device according to claim 1, wherein
the obtaining includes dividing the distance D by an adjustment value A (A is a numerical value larger than 1).

6. The Self-Organizing Map learning device according to claim 5, wherein
the adjustment value A is expressed by a function f(t) that decreases as the learning period t of time increases.

7. The Self-Organizing Map learning device according to claim 5, wherein
a value between f(t)−b and f(t)+b is set randomly with use of an adjustment width b as the adjustment value A with respect to a function f(t) that decreases as a learning period t of time increases.

8. The Self-Organizing Map learning device according to claim 7, wherein
the adjustment width b is set variable with respect to the learning period t of time.

9. The Self-Organizing Map learning device according to claim 5, wherein
the adjustment value A follows a normal distribution which takes f(t) as an average value with respect to a function f(t) that decreases as a learning period t of time increases.

10. The Self-Organizing Map learning device according to claim 9, wherein
variance of the normal distribution is set variable with respect to the learning period t of time.

11. The Self-Organizing Map learning device according to claim 1, wherein
the distance includes a Euclidean distance.

12. The Self-Organizing Map learning device according to claim 1, wherein
the distance includes a Hamming distance.

13. A state determination device comprising:
circuitry configured to:
acquire an input vector from observation data obtained by measurement of an unknown event of an observation space;
convert the input vector into data in a latent space with use of a Self-Organizing Map learned by the learning method according to claim 1; and
determine a state of the observation space based on SOM output data acquired by the converting.

14. A failure determination device comprising:
circuitry configured to:
acquire an input vector from measurement data obtained by measurement of an unknown event of an observation space;
convert the input vector into data in a latent space with use of a Self-Organizing Map learned by the learning method according to claim 1; and
determine a type of failure that has occurred in the observation space based on SOM output data acquired by the converting.

15. A Self-Organizing Map learning method for converting an observation space into a latent space that is lower dimensional than the observation space, including:
a distance calculating step of obtaining a distance D between an input vector in the observation space and a reference vector of each neuron in the latent space;
a smallest value neuron specifying step of specifying a smallest value neuron having the smallest distance D;
a neuron selecting step of selecting M (M is an integer smaller than L) selection neurons from the L (L is equal to or larger than 2) smallest value neurons in a case where the L smallest value neurons are present; and
an updating step of updating the reference vector of each neuron in the latent space with the M selection neurons as winner neurons.

16. A non-transitory computer readable medium storing a Self-Organizing Map learning program that performs a Self-Organizing Map learning method of converting an observation space into a latent space that is lower dimensional than the observation space, causing a computer to execute:
a distance calculating process of obtaining a distance D between an input vector in the observation space and a reference vector of each neuron in the latent space;
a smallest value neuron specifying process of specifying a smallest value neuron having the smallest distance D;
a neuron selecting process of selecting M (M is an integer smaller than L) selection neurons from the L (L is equal to or larger than 2) smallest value neurons in a case where the L smallest value neurons are present; and
an updating process of updating the reference vector of each neuron in the latent space with the M selection neurons as winner neurons.

17. A state determination method including:
an input vector acquiring step of acquiring an input vector from measurement data obtained by measurement of an unknown event of an observation space;
a converting step of converting the input vector into data in a latent space with use of a Self-Organizing Map learned by the learning method according to claim 15; and
a determining step of determining a state of the observation space based on SOM output data acquired in the converting step.

18. A non-transitory computer readable medium storing a state determination program, causing a computer to execute:
an input vector acquiring process of acquiring an input vector from observation data obtained by measurement of an unknown event of an observation space;
a converting process of converting the input vector into data in a latent space with use of a Self-Organizing Map learned by the learning method according to claim 16; and
a determining process of determining a state of he observation space based on SOM output data acquired in the converting process.
